(19) United States
(12) Patent Application Publication
(10) Pub. No.: US 2025/0273004 A1
(43) Pub. Date: Aug. 28, 2025

(54) APPARATUS AND METHOD FOR DETECTING LANDMARKS EVALUATING BREAST AESTHETICS BASED ON ARTIFICIAL INTELLIGENCE

(71) Applicant: SEOUL NATIONAL UNIVERSITY HOSPITAL, Seoul (KR)

(72) Inventors: Yujin MYUNG, Seongnamsi (KR); Joseph PARK, Seongnamsi (KR); Jin Byeong PARK, Seongnamsi (KR); Myeong Ju KIM, Seoul (KR)

(21) Appl. No.: 19/064,499

(22) Filed: Feb. 26, 2025

(30) Foreign Application Priority Data
Feb. 28, 2024 (KR) 10-2024-0028728
Feb. 18, 2025 (KR) 10-2025-0021070

(51) Int. Cl. G06V 40/10; G06V 10/32; G06V 10/44; G06V 10/82

(52) U.S. Cl. CPC G06V 40/10; G06V 10/32; G06V 10/44; G06V 10/82

(57) ABSTRACT

The present invention relates to an apparatus and a method for detecting landmarks for evaluating breast aesthetics based on artificial intelligence, which enable detection of landmarks used for evaluating breast aesthetics by utilizing a deep learning model, and is characterized by including: an image acquisition unit configured to acquire a photograph of a breast to be evaluated for aesthetics; and landmarks detection unit configured to input the breast photograph acquired through the image acquisition unit into a pre-trained landmark detection model to detect landmarks used for evaluating breast aesthetics.

### CROSS-REFERENCE TO RELATED APPLICATION

This application claims priority to Korean Patent Application No. 10-2024-0028728, filed on Feb. 28, 2024, and Korean Patent Application No. 10-2025-0021070, filed on Feb. 18, 2025, the entire contents of which are incorporated herein by reference.

### BACKGROUND

### 1. Field

The present invention relates to an apparatus and a method for detecting landmarks for evaluating breast aesthetics based on artificial intelligence, and more particularly, to an apparatus and a method for detecting landmarks for evaluating breast aesthetics based on artificial intelligence, which enable detection of landmarks used for evaluating breast aesthetics by utilizing a deep learning model.

### 2. Description of the Related Art

Breast cancer is the most common cancer in women and has a trend of increasing prevalence worldwide.

Surgical procedures to remove tumors are needed to treat breast cancer.

Patients who have undergone mastectomy experience psychological side effects such as reduced self-esteem and depression due to loss of femininity as well as changes in the appearance of the body.

Therefore, breast reconstruction surgery may be said to be a field of rehabilitation that restores the breast of woman who has undergone mastectomy to a normal appearance, thereby helping them gain confidence and relieve psychological distress.

As such, the aesthetic results of surgery may be evaluated after breast reconstruction surgery or breast plastic surgery for cosmetic purposes, but conventionally, there is a problem in that consistency, reliability, and objectivity are greatly deteriorated because subjective evaluations of a doctor and a patient are greatly relied on.

### SUMMARY

The present invention has been devised to solve the above-described conventional problems, and an object of the present invention is to provide an apparatus and a method for detecting landmarks for evaluating breast aesthetics based on artificial intelligence, which enable detection of landmarks used for evaluating breast aesthetics by utilizing a deep learning model.

In order to achieve the above-described object, an apparatus for detecting landmarks for evaluating breast aesthetics based on artificial intelligence according to the present invention is characterized by including an image acquisition unit configured to acquire a photograph of a breast to be evaluated for aesthetics; and a landmark detection unit configured to input the breast photograph acquired through the image acquisition unit into a pre-trained landmark detection model to detect landmarks used for evaluating breast aesthetics.

In addition, the apparatus for detecting landmarks for evaluating breast aesthetics based on artificial intelligence according to the present invention is characterized by further including an image pre-processing unit configured to modify a ratio and a size of the breast photograph acquired through the image acquisition unit, and to normalize pixel values.

In addition, the apparatus for detecting landmarks for evaluating breast aesthetics based on artificial intelligence according to the present invention is characterized by further including a training unit configured to train the landmark detection model by acquiring, as training data, breast photographs annotated with landmarks used for evaluating breast aesthetics.

In addition, in the apparatus for detecting landmarks for evaluating breast aesthetics based on artificial intelligence according to the present invention, the landmarks used for evaluating breast aesthetics are characterized by including at least one of a sternal notch, an umbilicus, both nipples, and a lower boundary point of each breast.

In addition, in the apparatus for detecting landmarks for evaluating breast aesthetics based on artificial intelligence according to the present invention, the training unit is configured to train the landmark detection model by receiving, as input, distances required for calculating a breast asymmetry index, and the landmark detection model is configured to also estimate the distances required for calculating the breast asymmetry index together when detecting landmarks from an input breast photograph.

In addition, in the apparatus for detecting landmarks for evaluating breast aesthetics based on artificial intelligence according to the present invention, the distances required for calculating the breast asymmetry index include at least one of a distance from sternal notch to nipple, a distance from nipple to sternum, a distance from nipple to inframammary fold, and a breast base width.

In addition, in the apparatus for detecting landmarks for evaluating breast aesthetics based on artificial intelligence according to the present invention, the breast asymmetry index is characterized by including at least one of a breast retraction assessment (BRA), a lower breast contour (LBC), an upward nipple retraction (UNR), a breast compliance evaluation (BCE), a breast contour difference (BCD), a breast area difference (BAD), and a breast overlap difference (BOD).

In addition, in order to achieve the above-described object, a method for detecting landmarks for evaluating breast aesthetics based on artificial intelligence according to the present invention is characterized by including an image acquisition step of acquiring a photograph of a breast to be evaluated for aesthetics; and a landmark detection step of inputting the breast photograph acquired through the image acquisition step into a pre-trained landmark detection model and detecting landmarks used for evaluating breast aesthetics.

In addition, method for detecting landmarks for evaluating breast aesthetics based on artificial intelligence according to the present invention is characterized by further including an image pre-processing step of modifying a ratio and a size of the breast photograph acquired through the image acquisition step and normalizing pixel values.

In addition, method for detecting landmarks for evaluating breast aesthetics based on artificial intelligence according to the present invention is characterized by further including a training step of training the landmark detection model by acquiring, as training data, breast photographs annotated with landmarks used for evaluating breast aesthetics.

In addition, in the method for detecting landmarks for evaluating breast aesthetics based on artificial intelligence according to the present invention, the landmarks used for evaluating breast aesthetics are characterized by including at least one of a sternal notch, an umbilicus, both nipples, and a lower boundary point of each breast.

In addition, in the method for detecting landmarks for evaluating breast aesthetics based on artificial intelligence according to the present invention, in the training step, the landmark detection model is trained by receiving, as input, distances required for calculating a breast asymmetry index, and in the landmark detection step, the landmark detection model also estimate the distances required for calculating the breast asymmetry index together when detecting landmarks from an input breast photograph.

In addition, in the method for detecting landmarks for evaluating breast aesthetics based on artificial intelligence according to the present invention, the distances required for calculating the breast asymmetry index include at least one of a distance from sternal notch to nipple, a distance from nipple to sternum, a distance from nipple to inframammary fold, and a breast base width.

In addition, in the method for detecting landmarks for evaluating breast aesthetics based on artificial intelligence according to the present invention, the breast asymmetry index includes at least one of breast retraction assessment (BRA), lower breast contour (LBC), upward nipple retraction (UNR), breast compliance evaluation (BCE), breast contour difference (BCD), breast area difference (BAD), and breast overlap difference (BOD).

The details of other embodiments are included in the “Detailed Description” and the accompanying “Drawings.”

Advantages and/or features of the present invention, and methods of accomplishing the same, will become apparent by reference to various embodiments, which are described in detail below in conjunction with the accompanying drawings.

It should be noted, however, that the present invention is not limited to the components of each embodiment disclosed below, but may be implemented in various different forms, and each embodiment disclosed in present specification are provided only to complete the disclosure of the present invention and to fully convey the scope of the present invention to those skilled in the art to which the present invention pertains, and that the present invention is defined only by the scope of each claim of the claims.

According to the present invention, it is possible to automatically detect landmarks used for aesthetic evaluation of a surgical result after breast reconstruction or breast plastic surgery following mastectomy for breast cancer treatment, thereby saving time and reducing errors.

In addition, by providing dimension-based asymmetry index and dimensionless breast asymmetry index, it becomes possible to provide more accurate and standardized measurements of breast asymmetry.

### BRIEF DESCRIPTION OF THE DRAWINGS

FIG. 1 is a diagram schematically showing a configuration of an apparatus for detecting landmarks for evaluating breast aesthetics based on artificial intelligence according to an embodiment of the present invention.

FIG. 2 is a diagram exemplarily showing landmarks used for evaluating breast aesthetics as applied in the present invention.

FIG. 3 is a diagram exemplarily showing distances required for calculating a breast asymmetry index as applied in the present invention.

FIGS. 4 and 5A-5B are diagrams for describing functions provided by the apparatus for detecting landmarks for evaluating breast aesthetics based on artificial intelligence according to the present invention.

FIGS. 6 and 7 are flowcharts for describing a method for detecting landmarks for evaluating breast aesthetics based on artificial intelligence according to an embodiment of the present invention.

FIG. 8 is a diagram showing Bland-Altman plots for a distance (SN-N) from sternal notch to nipple, a distance (N-S) from nipple to sternum, and a breast base width (BBW), based on experimental results.

FIG. 9 is a diagram showing the Bland-Altman plot for a distance (N-IMF) from nipple to inframammary fold, based on experimental results.

### DETAILED DESCRIPTION

Before the present invention is described in detail, it should be noted that the terms and words used in the present specification should not be construed as being unconditionally limited to their ordinary or dictionary meanings, and that the inventors of the present invention may appropriately define and use concepts of various terms in order to describe their own invention in the best possible way, and furthermore, these terms and words should be interpreted as meanings and concepts consistent with the technical concept of the present invention.

In other words, it should be noted that the terms used in this specification are only used to describe preferred embodiments of the present invention, and are not used with the intention of specifically limiting the content of the present invention, and these terms are defined in consideration of the various possibilities of the present invention.

Also, it should be noted that, in the present specification, expressions in singular form may include expressions in plural form unless the context clearly indicates otherwise, and similarly, expressions in plural form may include singular meanings.

Throughout the present specification, when a component is described as “including” another component, unless specifically stated to the contrary, it may mean that any other component may be further included rather than excluding any other component.

Furthermore, it should be noted that when a component is described as being “present inside” or “connected to” another component, the component may be directly connected to or in contact with the other component, or may be spaced apart from the other component by a certain distance, and when the components are spaced apart from a certain distance, there may exist a third component or means for fixing or connecting the corresponding component to the other component, and the description of the third component or means may be omitted.

On the other hand, when a component is described as being “directly connected to” or “directly coupled with” another component, it should be understood that there are no third components or means present.

Likewise, other expressions describing a relationship between each component, that is, “between” and “immediately between,” or “adjacent to” and “directly adjacent to” and the like, should be interpreted to have the same meaning.

In addition, in the present specification, it should be noted that terms such as “one surface,” “the other surface,” “one side,” “the other side,” “first,” “second,” if used, are merely intended to distinguish one component from another, and these terms are not construed as limiting the meaning of the corresponding components.

Further, in the present specification, it should be understood that terms related to positions such as “upper,” “lower,” “left,” “right,” if used, indicate relative positions in the corresponding drawings with respect to the corresponding components, and these terms related to positions should not be understood as referring to absolute positions unless absolute positions are specified with respect to these positions.

Moreover, in the specification of the present invention, it should be noted that terms such as “unit,” “group,” “module,” “apparatus,” if used, mean a unit capable of processing one or more functions or operations, and may be implemented by hardware or software, or a combination of hardware and software.

In addition, in the present specification, when reference numerals are given to respective components in the drawings, the same reference numerals are given to the same components even if such component is illustrated in different drawings, that is, the same reference numerals throughout the specification indicate the same components.

In the drawings attached to the present specification, the size, position, coupling relationship, and the like of each component constituting the present invention may be described in an exaggerated, reduced, or omitted manner in order to sufficiently clearly convey the spirit of the present invention or for convenience of description, and thus the proportion or scale thereof may not be strict.

In addition, in the following, in describing the present invention, detailed description of a configuration that is determined to unnecessarily obscure the gist of the present invention, for example, a known technology including a conventional technology, may be omitted.

Hereinafter, an apparatus and a method for detecting landmarks for evaluating breast aesthetics based on artificial intelligence according to a preferred embodiment of the present invention will be described in detail with reference to the accompanying drawings.

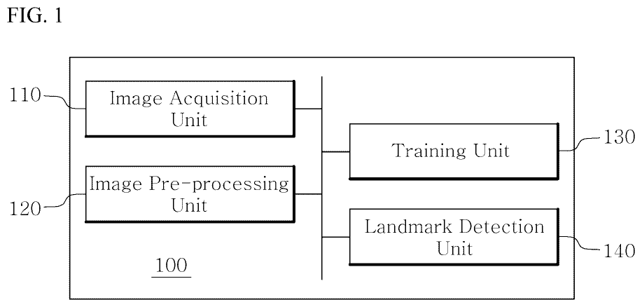

FIG. 1 is a diagram schematically showing a configuration of an apparatus for detecting landmarks for evaluating breast aesthetics based on artificial intelligence according to an embodiment of the present invention.

As shown in FIG. 1, the apparatus 100 for detecting landmarks for evaluating breast aesthetics based on artificial intelligence according to an embodiment of the present invention may include an image acquisition unit 110, an image pre-processing unit 120, a training unit 130, a landmark detection unit 140, and the like.

In such a configuration, the image acquisition unit 110 may acquire a photograph of a breast to be evaluated for aesthetics.

The photograph acquired through the image acquisition unit 110 may be a photograph taken from the front side of the breast to be evaluated for aesthetics.

In addition, the image acquisition unit 110 may acquire breast photographs annotated with landmarks used for evaluating breast aesthetics, as training data necessary for training of a landmark detection model.

The training data used for training the landmark detection model may be breast photographs in which landmarks used for evaluating breast aesthetics through an annotation process are indicated by coordinates.

The annotation is an operation of adding meaningful information to training data, and in visual data such as images or videos, the annotation displays a specific object or point and adds a description, so that a machine learning model may recognize and learn the corresponding object.

In the embodiment of the present invention, the breast photograph used as training data may be implemented as a frontal breast photograph in which 30 landmarks, as an example used for evaluating breast aesthetics, are indicated by coordinates.

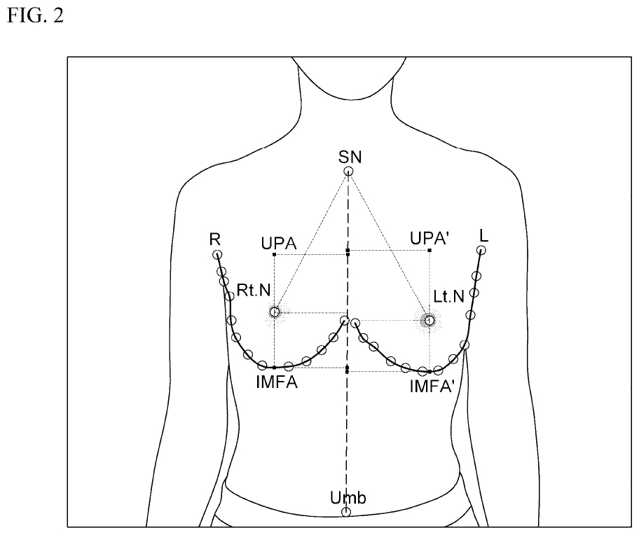

The landmarks used for evaluating breast aesthetics may include, but are not limited to, 1 sternal notch, 1 umbilicus, 2 nipples, and lower boundary points of each breast (26 points, 13 points for each of the right and left breasts), as shown in FIG. 2.

As described above, the landmarks displayed on the breast photograph may be marked by a single plastic surgeon to improve integrity, but are not limited thereto.

The image pre-processing unit 120 may modify a ratio and a size of the breast photograph acquired through the image acquisition unit 110, and normalize pixel values to ensure consistency of the breast photographs acquired through the image acquisition unit 110.

Specifically, the image pre-processing unit 120 may adjust an image ratio of the breast photograph acquired through the image acquisition unit 110, normalize an image size, and perform 8-bit normalization to scale pixel value to a range between 0 and 255.

The training unit 130 may train the landmark detection model in a supervised learning manner by using the training data collected through the image acquisition unit 110 or the training data pre-processed by the image pre-processing unit 120.

Here, the training data used for training the landmark detection model may be a pre-processed image in the image pre-processing unit 120.

In addition, when training the landmark detection model by using the training data collected through the image acquisition unit 110 or the training data pre-processed by the image pre-processing unit 120, the training unit 130 may train the landmark detection model by receiving, as input, distances required for calculating a breast asymmetry index.

As such, the landmark detection model trained by additionally receiving, as input, distances required for calculating the breast asymmetry index may also estimate the distances required for calculating the breast asymmetry index together when detecting landmarks from an input breast photograph.

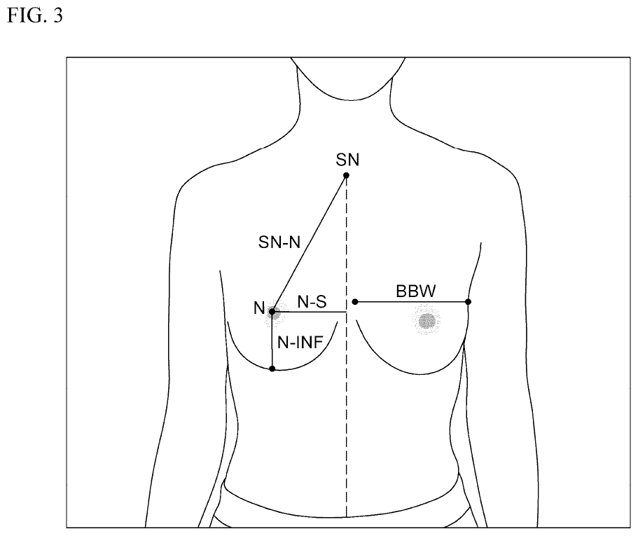

Here, the distances required for calculating the breast asymmetry index may include, but is not limited to, a distance (SN-N) from sternal notch (SN) to nipple (N), a distance (S-N) from nipple (S) to sternum (N), a distance (S-IMF) from nipple (N) to inframammary fold (IMF), and a breast base width (BBW), as shown in FIG. 3.

The breast asymmetry index may include at least one of a breast retraction assessment (BRA), a lower breast contour (LBC), an upward nipple retraction (UNR), a breast compliance evaluation (BCE), a breast contour difference (BCD), a breast area difference (BAD), and a breast overlap difference (BOD).

The above-described training unit 130 may train the landmark detection model such that the landmark detection model is optimized to accurately detect landmarks of breast from new input data (breast photograph) and to reduce errors.

The landmark detection unit 140 may detect landmarks used for evaluating breast aesthetics by inputting the photograph of breast to be evaluated for aesthetics, into the landmark detection model trained by the training unit 130.

Here, the breast photograph input to the landmark detection model may be the pre- processed image in the image pre-processing unit 120.

The landmark detection model applied in the present invention may be implemented, as an example, as a convolutional neural network (CNN), such as ResNet, DenseNet, YOLO, EfficientNet, but is not limited thereto.

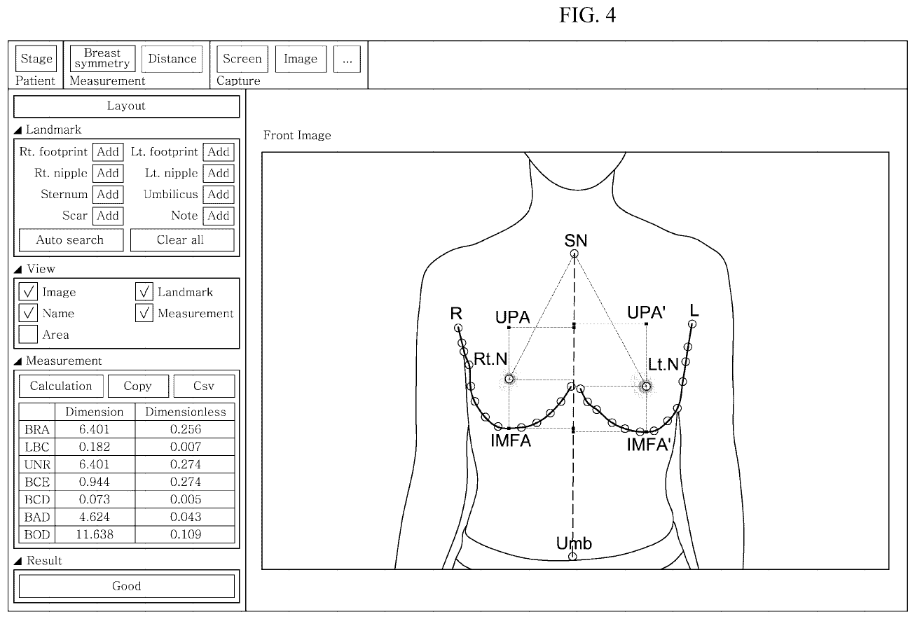

The apparatus 100 for detecting landmarks for evaluating breast aesthetics based on artificial intelligence according to the present invention, configured as described above, may provide breast landmarks detected through the landmark detection model, breast asymmetry indices (dimension-based and dimensionless), breast symmetry comparison, and manual distance measurement tool for estimating distances in centimeters, as shown in FIG. 4.

As mentioned above, since the breast asymmetry indices are calculated based on centimeters (dimension-based) or pixels (dimensionless), it may be compared with an actual measurement value to verify the accuracy of the apparatus 100 for detecting landmarks for evaluating breast aesthetics based on artificial intelligence according to the present invention. This will be described again below.

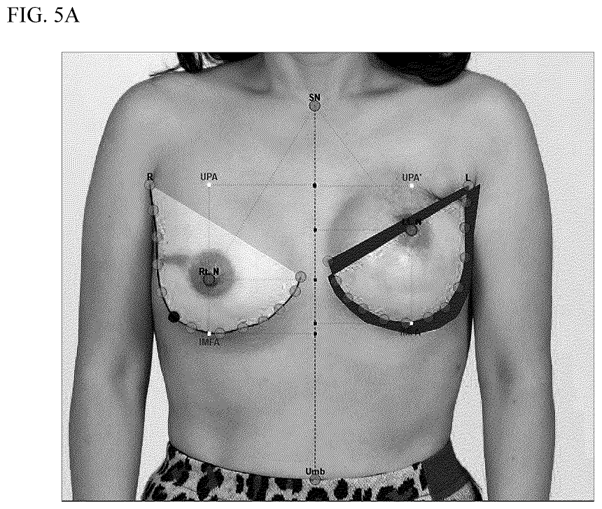

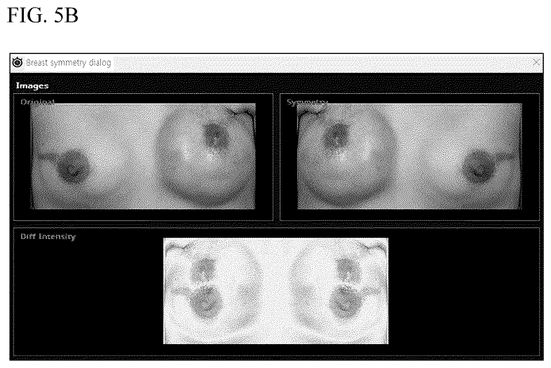

Further, the apparatus 100 for detecting landmarks for evaluating breast aesthetics based on artificial intelligence according to the present invention may provide a breast symmetry function, as shown in FIG. 5A and FIG. 5B.

In FIG. 5A, the orange shade represents the contour of the breast, and the blue shade represents the breast overlap difference (BOD). In FIG. 5B, an overlapped image of the breast may be provided to better visualize the misalignment of the nipple-areola complexes and the contour between the two breasts.

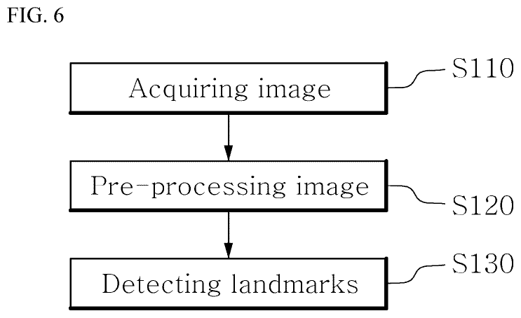

FIG. 6 is a flowchart for describing a method for detecting landmarks for evaluating breast aesthetics based on artificial intelligence according to an embodiment of the present invention.

A method for detecting landmarks for evaluating breast aesthetics based on artificial intelligence according to the present invention may proceed on substantially the same configuration as the apparatus 100 for detecting landmarks for evaluating breast aesthetics based on artificial intelligence shown in FIG. 1.

First, in step S110, the photograph of breast to be evaluated for aesthetics may be acquired.

The photograph acquired through the foregoing step S110 may be, but is not limited to, a photograph taken from the front side of the breast to be evaluated for aesthetics.

Then, in step S120, the ratio and the size of the breast photograph may be modified, and pixel values may be normalized in order to ensure consistency of the breast photographs acquired through the foregoing step S110.

Specifically, in the foregoing step S120, the image ratio of the breast photograph acquired through the foregoing step S110 may be adjusted, the image size may be normalized, and 8-bit normalization may be performed to scale pixel value to a range between 0 and 255.

And, in step S130, landmarks used for evaluating breast aesthetics may be detected by inputting either the breast photograph acquired through the foregoing step S110 or the breast photograph pre-processed in the foregoing step S120 into a pre-trained landmark detection model.

In the foregoing step S130, the landmark detection model may also estimate the distances required for calculating the breast asymmetry index together when detecting landmarks from the input breast photograph.

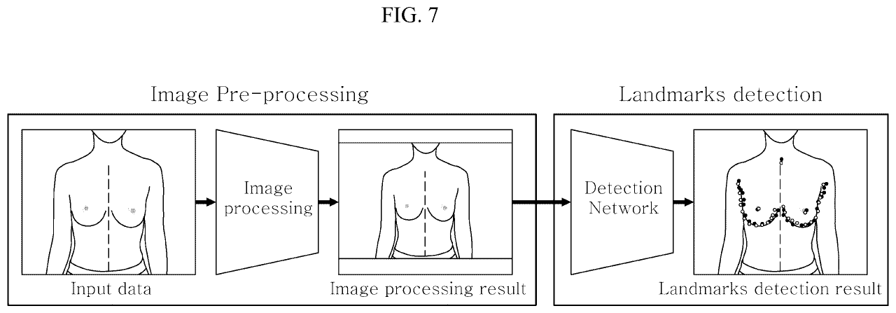

In the foregoing step S130, the breast photograph input to the landmark detection model may be a pre-processed image, as shown in FIG. 7 (see FIG. 7).

Meanwhile, the landmark detection model applied to the present invention may be trained by receiving, as training data, the breast photograph annotated with landmarks used for evaluating breast aesthetics, before detecting the landmarks used for evaluating breast aesthetics in the input breast photograph.

Here, the breast photograph used as the training data for the landmark detection model may be implemented as the frontal breast photograph in which 30 landmarks (1 sternal notch, 1 umbilicus, 1 right nipple, 1 left nipple, 13 lower boundary points of the right breast, 13 lower boundary points of the left breast) are displayed as an example used for evaluating breast aesthetics.

As such, breast photographs annotated with landmarks used for evaluating breast aesthetics may be pre-processed before being input to the landmark detection model for training, in order to ensure consistency of the breast photographs.

Specifically, the breast photographs used as training data for the landmark detection model, that is, breast photographs annotated with landmarks used for evaluating breast aesthetics, may be subjected to image ratio adjustment, image size standardization, and 8-bit normalization to scale pixel values to range between 0 and 255, before being input as training data for the landmark detection model.

When the landmark detection model is trained by receiving, as training data, breast photographs annotated with landmarks used for evaluating breast aesthetics, it may also be trained by receiving, as input, distances required for calculating the breast asymmetry index.

Here, the distances required for calculating the breast asymmetry index may include the distance (SN-N) from sternal notch (SN) to nipple (N), the distance (S-N) from nipple (S) to sternum N, the distance (S-IMF) from nipple (N) to inframammary fold (IMF), and the breast base width (BBW).

### Experimental Example

As described above, in order to verify the accuracy of the apparatus 100 for detecting landmarks for evaluating breast aesthetics based on artificial intelligence according to the present invention, in this experiment, a value measured through the apparatus 100 for detecting landmarks is compared with an actual measured value.

In the present experiment, in order to verify the accuracy of the apparatus 100 for detecting landmarks for evaluating breast aesthetics based on artificial intelligence according to the present invention, the experiment was conducted on a total of 100 women diagnosed with breast cancer.

The landmarks used for verifying the accuracy of the apparatus 100 for detecting landmarks according to the present invention may include the sternal notch (SN), the sternum, the nipple (N), the inframammary fold (IMF), an umbilicus, and the like, and the distance measured for verification may include the distance (SN-N) from sternal notches to nipple, the distance (N-S) from nipple to sternum, the distance (N-IMF) from nipple to inframammary fold, the breast base width (BBW), and the like, as shown in FIG. 3.

Table 1 shows the mean values and paired t-test between the values measured by the apparatus 100 for detecting landmarks for evaluating breast aesthetics based on artificial intelligence according to the present invention and the actual measured values, and it may be confirmed that the paired t-test shows statistical significance only in the distance (N-IMF) from nipple to inframammary fold, while the other measured values do not show statistical significance between the values measured by the apparatus 100 for detecting landmarks and the actual measured values.

TABLE 1

| | | | | | Upper | Lower |
|---|---|---|---|---|---|---|
| | Mean | | Paired t- | Mean | limit of | limit of |
| | Actual | Mean S- | test (p- | difference | agreement | agreement |
| | (cm) | Best (cm) | value) | (cm) | (cm)^{b} | (cm)^{b} |
| Sternal notch to nipple (Rt.) | 20.8 | 21.0 | 0.47 | −0.2 | 0.7 | −1.1 |
| Sternal notch to nipple (Lt.) | 20.8 | 20.8 | 0.32 | 0.1 | 1.4 | −1.2 |
| Nipple to sternum (Rt.) | 8.5 | 8.6 | 0.28 | −0.1 | 1.8 | −2.0 |
| Nipple to sternum (Lt.) | 8.8 | 8.8 | 0.49 | −0.1 | 2.0 | −2.2 |
| Nipple to inframammary (Rt.) | 6.6 | 4.0 | <0.001^{a} | 2.7 | 7.2 | −1.9 |
| Nipple to inframammary (Lt.) | 6.5 | 4.0 | <0.001^{a} | 2.6 | 7.0 | −1.8 |
| Breast base width (Rt.) | 12.6 | 12.5 | 0.45 | 0.1 | 2.6 | −2.4 |
| Breast base width (Lt.) | 12.6 | 12.3 | 0.46 | 0.2 | 2.7 | −2.2 |

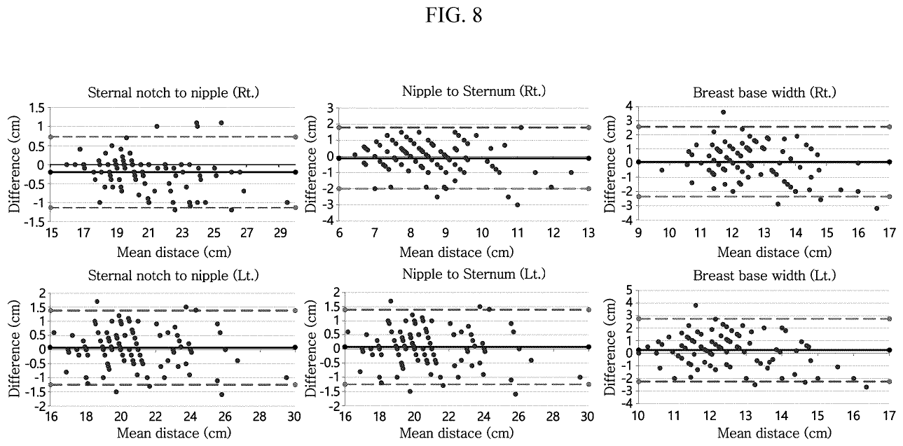

FIG. 8 is a diagram showing the Bland-Altman plots for the distance (SN-N) from sternal notch to nipple, the distance (N-S) from nipple to sternum, and the breast base width (BBW), based on experimental results, and it may be confirmed that the Brand-Altman plots for the distance (SN-N) from sternal notch to nipple, the distance (N-S) from nipple to sternum, and the breast base width (BBW), show a bias of less than 0.2 cm, and the upper limit of agreement and the lower limit of agreement are less than 3 cm.

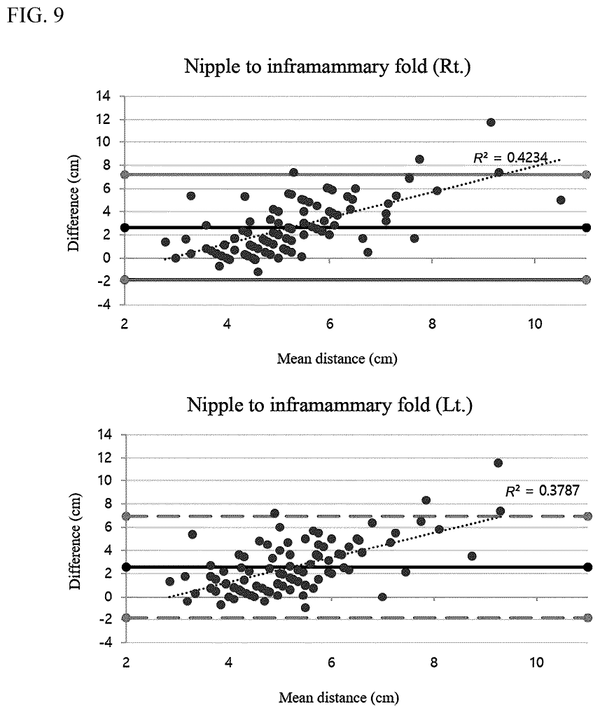

FIG. 9 is a diagram showing the Bland-Altman plot for the distance (N-IMF) from nipple to inframammary fold, based on experimental results, and it may be confirmed that the Bland-Altman plot for the distance (N-IMF) from nipple to inframammary fold, shows a high bias of 2.7 cm, while the upper limit of agreement and the lower limit of agreement are 7.2 cm and −1.9 cm, respectively. The discrepancy between the values measured by the apparatus 100 for detecting landmarks and the actual measured values increases as the distance from nipple to inframammary fold increases, resulting in a coefficient of determination of 0.4234 for the right breast and 0.3787 for the left breast.

Through the present experiment, it may be confirmed that the apparatus 100 for detecting landmarks according to the present invention measures a relatively accurate value.

That is, the automatic photometric analysis through the apparatus 100 for detecting landmarks according to the present invention measures accurate values for the distance (SN-N) from sternal notch to nipple, the distance (N-S) from nipple to sternum, and the breast base width (BBW). However, the distance (N-IMF) from nipple to inframammary fold shows a high bias with a positive coefficient of determination. This means that the more severe the breast ptosis, the less clearly the inframammary fold appears, and this is expected because the photometric analysis only measures the distance shown in the photograph, whereas the actual measurement measures the full length of the lower part of the breast.

The breast asymmetry indices such as breast retraction assessment (BRA), lower breast contour (LBC), breast contour difference (BCD), breast overlap difference (BOD), are essential to assess the success of breast reconstruction surgery.

These indices are based on photometric measurements using breast photographs.

As may be seen through the present experiment, the apparatus 100 for detecting landmarks for evaluating breast aesthetics based on artificial intelligence according to the present invention accurately measures the breast landmarks used for breast asymmetry index, and therefore, this index are also made accurate.

The method according to the embodiments described above and the operations by the apparatus for performing the same may be implemented, at least in part, by a computer program and stored in a computer-readable recording medium.

For example, it may be implemented together with a program product comprised of computer-readable medium including program code, which may be executed by a processor to perform any or all of the steps, operations, or processes described.

The computer may be any device that may be a computing device or integrated therewith, such as a desktop computer, laptop computer, notebook, smart phone, or the like. The computer is an apparatus that has one or more general and special purpose processors, memory, storage, and networking components (either wireless or wired). The computer may execute an operating system such as, for example, Microsoft's Windows compatible operating system, Apple OS X or iOS, Linux distribution, or Google's Android OS.

The computer-readable recording medium includes all kinds of recording identification devices in which data that may be read by the computer is stored. Examples of the computer-readable recording medium include ROM, RAM, CD-ROM, magnetic tape, floppy disk, optical data storage identification device, and the like. In addition, the computer-readable recording medium may also be distributed over a network-connected computer system, allowing computer-readable code to be stored and executed in a distributed manner. In addition, functional programs, codes and code segments for implementing the present embodiments may be readily understood by one of ordinary skill in the art to which the present embodiments pertain.

Thus, according to the present invention, it is possible to automatically detect landmarks used for aesthetic evaluation of a surgical result after breast reconstruction or breast plastic surgery following mastectomy for breast cancer treatment, thereby saving time and reducing errors.

In addition, by providing dimension-based asymmetry index and dimensionless breast asymmetry index, it becomes possible to provide more accurate and standardized measurements of breast asymmetry.

In addition, the dimensionless index may be helpful when physical measurements are not available.

In addition, it is possible to provide information for patient consultation, surgical planning, and result assessment.

Thus, although the several preferred embodiments of the present invention have been described above with reference to some examples, the description of the various embodiments described in the section “Detailed Description” is merely illustrative, and it will be readily understood by those skilled in the art to which the present invention pertains that present invention may be carried out with various modifications or through equivalent implementations, based on the above description.

In addition, it should be noted that the present invention is not limited by the above description because the present invention may be implemented in other various forms, and the above description is merely provided to complete the disclosure of the present invention and to fully convey the scope of the invention to those skilled in the art to which the present invention pertains, and the present invention is defined only by each claim of the claims.

What is claimed is:

1. An apparatus for detecting landmarks for evaluating breast aesthetics based on artificial intelligence, comprising:
an image acquisition unit configured to acquire a photograph of a breast to be evaluated for aesthetics; and
landmarks detection unit configured to input the breast photograph acquired through the image acquisition unit into a pre-trained landmark detection model to detect landmarks used for evaluating breast aesthetics.

2. The apparatus for detecting landmarks for evaluating breast aesthetics based on artificial intelligence according to claim 1, further comprising:
an image pre-processing unit configured to modify a ratio and a size of the breast photograph acquired through the image acquisition unit, and to normalize pixel values.

3. The apparatus for detecting landmarks for evaluating breast aesthetics based on artificial intelligence according to claim 1, further comprising:
a training unit configured to train the landmark detection model by acquiring, as training data, breast photographs annotated with landmarks used for evaluating breast aesthetics.

4. The apparatus for detecting landmarks for evaluating breast aesthetics based on artificial intelligence according to claim 3, wherein
the landmarks used for evaluating breast aesthetics comprise at least one of a sternal notch, an umbilicus, both nipples, and a lower boundary point of each breast.

5. The apparatus for detecting landmarks for evaluating breast aesthetics based on artificial intelligence according to claim 3, wherein
the training unit is configured to train the landmark detection model by receiving, as input, distances required for calculating a breast asymmetry index, and
the landmark detection model is configured to also estimate the distances required for calculating the breast asymmetry index together when detecting landmarks from an input breast photograph.

6. The apparatus for detecting landmarks for evaluating breast aesthetics based on artificial intelligence according to claim 5, wherein
the distances required for calculating the breast asymmetry index comprise at least one of a distance from sternal notch to nipple, a distance from nipple to sternum, a distance from nipple to inframammary fold, and a breast base width.

7. The apparatus for detecting landmarks for evaluating breast aesthetics based on artificial intelligence according to claim 5, wherein
the breast asymmetry index comprises at least one of a breast retraction assessment (BRA), a lower breast contour (LBC), an upward nipple retraction (UNR), a breast compliance evaluation (BCE), a breast contour difference (BCD), a breast area difference (BAD), and a breast overlap difference (BOD).

8. A method for detecting landmarks for evaluating breast aesthetics based on artificial intelligence, comprising:
an image acquisition step of acquiring a photograph of a breast to be evaluated for aesthetics; and
a landmark detection step of inputting the breast photograph acquired through the image acquisition step into a pre-trained landmark detection model and detecting landmarks used for evaluating breast aesthetics.

9. The method for detecting landmarks for evaluating breast aesthetics based on artificial intelligence according to claim 8, further comprising:
an image pre-processing step of modifying a ratio and a size of the breast photograph acquired through the image acquisition step and normalizing pixel values.

10. The method for detecting landmarks for evaluating breast aesthetics based on artificial intelligence according to claim 8, further comprising:
a training step of training the landmark detection model by acquiring, as training data, breast photographs annotated with landmarks used for evaluating breast aesthetics.

11. The method for detecting landmarks for evaluating breast aesthetics based on artificial intelligence according to claim 10, wherein
the landmarks used for evaluating breast aesthetics comprise at least one of a sternal notch, an umbilicus, both nipples, and a lower boundary point of each breast.

12. The method for detecting landmarks for evaluating breast aesthetics based on artificial intelligence according to claim 10, wherein
in the training step, the landmark detection model is trained by receiving, as input, distances required for calculating a breast asymmetry index, and
in the landmark detection step, the landmark detection model also estimate the distances required for calculating the breast asymmetry index together when detecting landmarks from an input breast photograph.

13. The method for detecting landmarks for evaluating breast aesthetics based on artificial intelligence according to claim 12, wherein
the distances required for calculating the breast asymmetry index comprise at least one of a distance from sternal notch to nipple, a distance from nipple to sternum, a distance from nipple to inframammary fold, and a breast base width.

14. The method for detecting landmarks for evaluating breast aesthetics based on artificial intelligence according to claim 12, wherein
the breast asymmetry index comprises at least one of a breast retraction assessment (BRA), a lower breast contour (LBC), an upward nipple retraction (UNR), a breast compliance evaluation (BCE), a breast contour difference (BCD), a breast area difference (BAD), and a breast overlap difference (BOD).
